(19) United States
(12) Patent Application Publication
(10) Pub. No.: US 2011/0015951 A1
(43) Pub. Date: Jan. 20, 2011

(54) Evaluation of website visitor based on value grade

(75) Inventors: Kaili Lv, Hangzhou (CN); Zheng Zhang, Hangzhou (CN); Bingyang Hua, Hangzhou (CN); Jie Su, Hangzhou (CN); Zengguang Liu, Hangzhou (CN); Chaofeng Meng, Hangzhou (CN); Huaibin Yuan, Hangzhou (CN); Weicong Chen, Hangzhou (CN)

Correspondence Address: VAN PELT, YI & JAMES LLP, 10050 N. FOOTHILL BLVD #200, CUPERTINO, CA, 95014, US

(73) Assignee: Alibaba Group Holding Limited

(21) Appl. No.: 12/804,134

(22) Filed: Jul. 13, 2010

(30) Foreign Application Priority Data
Jul. 14, 2009 (CN) 200910159499.X

(51) Int. Cl. G06F 17/18; G06Q 40/00

(52) U.S. Cl. 705/4; 702/181

(57) ABSTRACT

Evaluating website visitors includes: obtaining historical sample information of a plurality of past website visitors; based on the historical sample information, determining a plurality of value grades (cj) of the past website visitors and a respective plurality of rates of occurrence (P(cj)) for the plurality of value grades, wherein j=1, . . . , N, and N is an integer; determining a visitor characteristic probability (P(X)) and a plurality of conditional visitor characteristic probabilities given the plurality of value grades (P(X|cj)) associated with a current website visitor; and determining a plurality of conditional value grade probabilities given a visitor characteristic of the current website visitor ((P(c|X)) and selecting among the plurality of conditional value grade probabilities a likely value grade associated with the current website visitor, wherein j=1, . . . , N.

CROSS REFERENCE TO OTHER APPLICATIONS

This application claims priority to People's Republic of China Patent Application No. 200910159499.X entitled METHOD AND DEVICE FOR DETERMINING THE VALUE OF A WEBSITE VISITOR filed Jul. 14, 2009 which is incorporated herein by reference for all purposes.

### FIELD OF THE INVENTION

The present application relates to the field of Internet applications and in particular to a technique for determining the value of a website visitor.

### BACKGROUND OF THE INVENTION

Websites today often track visitors' profiles and behaviors and evaluate their value to provide more customized services and information. Most existing system track simple interactions such as the number of accesses, the number of visited pages, whether a specific page is visited, whether the visitor originates from a specific location, etc. Individual visitor's information and their relationships to the value of the visitor to the website, however, is often more complex. Existing visitor evaluation techniques typically do not adequately account for the more complex relationships. More accurate and efficient techniques are therefore needed.

### BRIEF DESCRIPTION OF THE DRAWINGS

Various embodiments of the invention are disclosed in the following detailed description and the accompanying drawings.

FIG. 1 is a functional diagram illustrating an embodiment of a programmed computer system for providing techniques for evaluating the value of a website visitor.

FIG. 2 is a flowchart illustrating an embodiment of a process for evaluating a website visitor according to an embodiment of the application.

FIG. 3 is a block diagram illustrating an embodiment of a system for evaluating a value grade of a visitor.

FIG. 4 is a block diagram illustrating another embodiment of a system for evaluating a value grade of a visitor.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In a website environment, information about a visitor and the value of the visitor to the website are often related. For example, if the visitor originates from Beijing, then he/she has a significant value with respect to webpage A, and if the visitor originates from Shanghai, then he/she has a significant value with respect to webpage B. A male visitor has a significant value of visiting a page C, and a female visitor has a significant value of visiting a page D. There are also more complex relationships which are frequently not obvious under direct observation. To improve the evaluation of website visitors, past information about website visitors is collected and processed to generate probabilistic information. A likely value grade of a current visitor is evaluated based upon probabilistic information, and optionally used to determine whether further action should take place in real time.

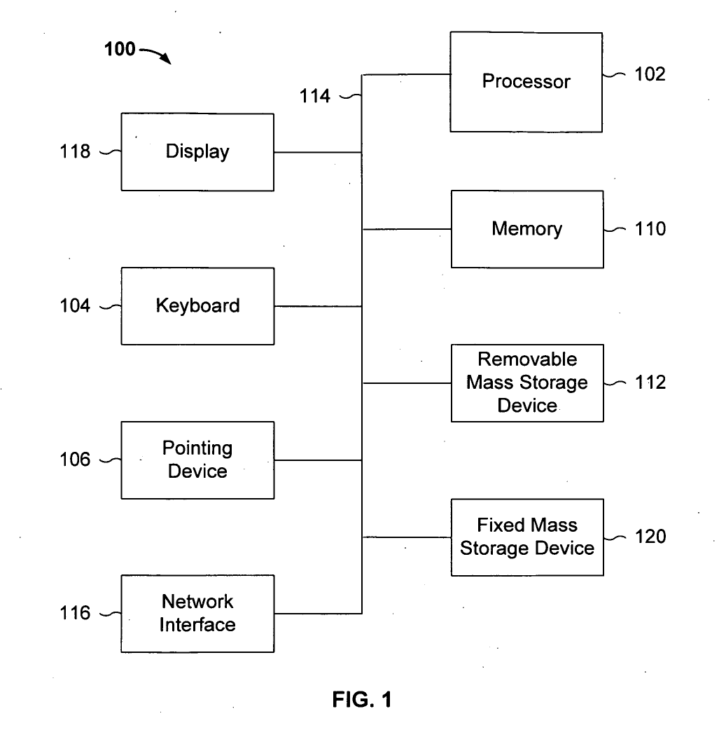

FIG. 1 is a functional diagram illustrating an, embodiment of a programmed computer system for providing techniques for evaluating the value of a website visitor. As will be apparent, other computer system architectures and configurations can be used to perform techniques for evaluating the value of a website visitor. Computer system 100, which includes various subsystems as described below, includes at least one microprocessor subsystem (also referred to as a processor or a central processing unit, CPU) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data and the output and display of data on output devices (e.g., display 118). In some embodiments, processor 102, for example, in communication with a memory 110 (or other computer readable storage medium element(s)/device(s)), includes and/or is used to implement techniques for managing insurance information as described herein.

Processor 102 is coupled bidirectionally with memory 110, which can include a first primary storage, typically a random access memory (RAM), and a second primary storage area, typically a read-only memory (ROM). As is well known in the art, primary storage can be used as a general storage area and as scratch-pad memory and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data and objects used by the processor 102 to perform its functions (e.g., programmed instructions). For example, primary storage devices 110 can include any suitable computer-readable storage media, described below, depending on whether, for example, data access needs to be bidirectional or unidirectional. For example, processor 102 can also directly and very rapidly retrieve and store frequently needed data in a cache memory (not shown).

A removable mass storage device 112 provides additional data storage capacity for the computer system 100 and is coupled either bidirectionally (read/write) or unidirectionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112, 120 can be incorporated, if needed, in standard fashion as part of primary storage 110 (e.g., RAM) as virtual memory. In some embodiments, insurance transaction information is also stored in the storage device.

In addition to providing processor 102 access to storage subsystems, bus 114 can be used to provide access to other subsystems and devices as well. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, trackball, or tablet and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card, or similar device, and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network, such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. A computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include machine code, as produced, for example, by a compiler, or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

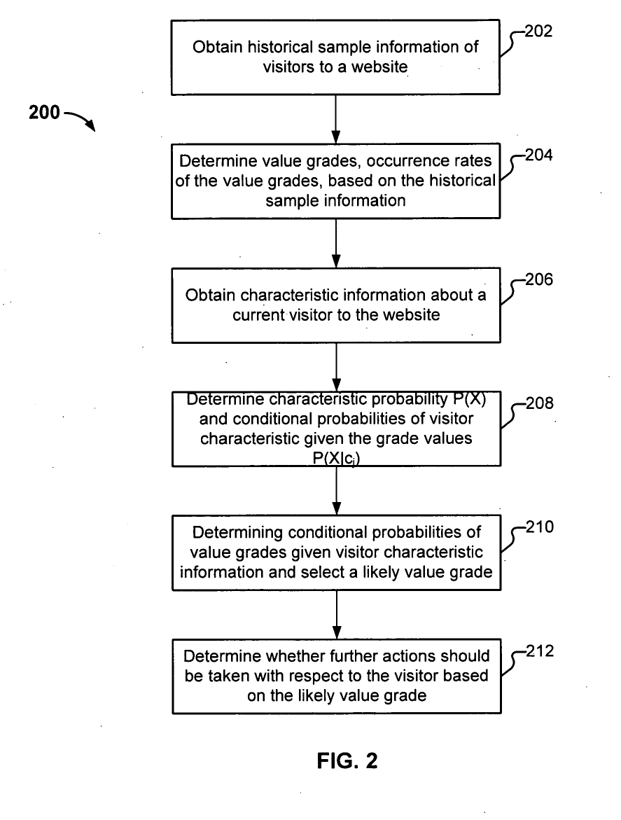

FIG. 2 is a flowchart illustrating an embodiment of a process for evaluating a website visitor according to an embodiment of the application. Process 200 may be performed on a system such as 100.

At 202, historical sample information of past visitors to a website is obtained. In this example, historical sample visitor characteristic information is categorized into “visitor attribute information” and “visitor behavior information”. “Visitor attribute information” refers to relatively static information including the gender, age, region, etc., of the visitor, and “visitor behavior information” refers to information that may vary dynamically in a short amount of time, e.g., the number of accesses to a website, a visited page, the duration of an access, whether the visitor has performed a specific behavior (e.g., chatting, emailing, etc.), the number of behaviors, etc.

At 204, based on the sample set, value grades for the past visitors and occurrence rates of the value grades are determined. A value grade is used to indicate the value a visitor has to a website. The determination of a value grade for each visitor is preferably objective, that is, visitors with the approximately the same characteristic information should receive similar value grades. In some embodiments, the value grade is evaluated in response to certain service demand (such as making a purchase on a website). For example, in the simplest case, based on whether the visitors eventually made a purchase on the website, visitors can be categorized into potential customers that “have value” and general visitors only interested in browsing and “have no value”. In other embodiments, the visitors can be categorized into more grades (e.g., “frequent purchaser”, “occasional purchaser”, “never purchased”, etc.) with respect to a specific service demand. Numerical values (1 for “have value”, 0 for “have no value”, etc.) may be mapped to the grades to facilitate computation in some embodiments.

The probabilities of each grades cⱼ in the data samples (also referred as the rate of occurrence for cⱼ) is determined as P(cⱼ), where j=1, 2, . . . , N, wherein N is the number of the predetermined value grades, cⱼ represents the value grade of the visitor. The probability rate of occurrence for each of the grades in the data samples can be established by counting the number of visitors associated with each grade, and the result is depicted in Table 1 as an example:

TABLE 1

| Grade | Probability |
|---|---|
| c₁ | P(c₁) |
| c₂ | P(c₂) |
| . . . | . . . |
| c_{N} | P(c_{N}) |

The above determination is done for the same set of data samples, that is, c₁, c₂, . . . c_{N} constitute a full set of events, so P(c₁)+P(c₂)+ . . . +P(c_{N})=1. For example, a set of data samples may include N=3 different value grades, wherein c₁, c₂, and c₃ represent “likely to make a purchase”, “somewhat likely to make a purchase”, and “no interest in purchasing”, respectively, and P(c₁), P(c₁), and P(c₁) correspond to 5%, 10%, and 85%, respectively.

Optionally and preferably, visitor characteristic probabilities P(X) is also determined at this stage. In this example, X represents visitor X's information and includes several characteristic components X₁, X₂, . . . X_{M}, which respectively represent specific sets of visitor characteristics with different ranges of values. For example:

X₁ corresponds to the age of the visitor and has three values in the range of {x₁₁, x₁₂, x₁₃};

X₂ corresponds to the number of times the visitor has visited the site, and has four values in the range of {x₂₁, x₂₂, x₂₃, x₂₄}; etc.

In this example, values of visitor information are preferably discretized. For example, “user access time” can be discretized into 24 values that correspond to 24 hours. Moreover, the visitor information corresponds to a limited set of values. In other words, for visitor information with an open range of values (e.g., the accumulated number of accesses, an accumulated duration of an access, etc.), the range of values shall also be mapped into a closed interval in response to a service demand. For example, “the accumulated number of accesses” can be mapped in a form of {“fewer than 5 times”, “5 to 10 times”, “more than 10 times”}.

Since the visitor characteristic information may take a limited number of values, and different values of multiple components X₁, X₂, . . . , X_{M} of X can be combined to result in respective possible values of X. There may be a large number of combinations. For example, assuming that X includes 6 components in total and each of which can take on 10 values, the number of all the combinations is then 10⁶. It is impractical, however, to take statistical samples for 10⁶ probabilities.

In practice, the number of calculations can be reduced by taking advantage of the fact that the respective components of X may be mutually independent or have a conditional relationship between each other. For example, the information such as the age, gender and region of a visitor is mutually independent, and there is a specific conditional relationship between “the number of visited pages” and “the duration of an access”.

According to Probability Theory, if X₁ and X₂ are mutually independent, then P(X₁X₂)=P(X₁)P(X₂), and if X₁ and X₂ are not independent, then P(X₁X₂)=P(X₁|X₂)(X₂) or P(X₁X₂)=P(X₂|X₁)(X₁). Independent and dependent visitor information can be processed respectively by the foregoing formulas to calculate P(X₁X₂ . . . X_{M}) directly.

For example, if components X₁-X₆ are mutually independent, then only 60 probability values (10 for each component) will need to be determined to calculate the probabilities that P(x) takes.

As another example, if X is composed of 6 components including mutually independent X₁, X₂ and X₃, and X₄ and X₅ in a conditional relationship with X₆, then the following can be determined:

$$\begin{matrix}P ( X ) = P ( {X}_{1} {X}_{2} {X}_{3} {X}_{4} {X}_{5} {X}_{6} ) \\ = P ( {X}_{1} {X}_{2} {X}_{3} ) P ( {X}_{4} {X}_{5} {X}_{6} ) \\ = P ( {X}_{1} ) P ( {X}_{2} ) P ( {X}_{3} ) P ( {X}_{4} \vert {X}_{6} ) P ( {X}_{5} \vert {X}_{6} ) P ( {X}_{6} )\end{matrix}$$

If X₁-X₆ each can take on 10 possible values, then the number of probabilities to be determined are based on: P(X₁), P(X₂), P(X₃) and P(X₆) each having 10 possible values; P(X₄|X₆) and P(X₅|X₆), each having 100 possible values, giving a total of 240 values to be determined. The amount of data to be processed is thus greatly reduced.

Components that are not independent (i.e., correlated components) have great influence upon the amount of data to be processed. In practice, however, characteristic components are often independent. In some embodiments, it is assumed that all components are mutually independent, and P(X) can be calculated based upon this assumption to further reduce the amount of data to be processed. As mentioned in the above example, if components X₁-X₆ are mutually independent, then only 60 probability values will be determined to calculate the probabilities that P(x) takes. Although the approximation will have some error, in practice, it has proven to generate acceptable results.

Optionally and preferably, conditional probabilities of visitor characteristic X given grade values, P(X|c) are computed for all X=X₁, X₂, . . . , X_{M} and cⱼ=c₁, c₂, . . . c_{N} combinations. P(Xᵢ|cⱼ) corresponds to the proportion of the number of times that a specific set of Xᵢ occurs in the data samples with a grade result of cⱼ and can be determined by tallying the number.

Alternatively, in some embodiments, P(X) and P(X|c) are computed for each visitor when he/she arrives at the website, based on the visitor's information.

At 206, a current website visitor arrives and characteristic information of the visitor, X, is obtained. Those skilled in the art can select a specific method for obtaining the visitor information in response to a specific demand. For example, “visitor attribute information” including the gender, age, region, etc., is obtained from registration information for the visitor. The geographical region of the visitor can alternatively be obtained from the IP address of the visitor. “Visitor behavior information” can be obtained via a management system of the website, such as a management log, website Cookies, a Customer Relationship Management (CRM) system, etc.

At 208, based on the characteristic information of the visitor, the characteristic probability P(X) and conditional probabilities of the visitor characteristic given the grade values P(X|cⱼ) for this visitor are determined. Assuming that a specific combination of visitor characteristics is designated as x₀, then P(X=x₀) represents the proportion of the number of occurrences of the value x₀ in all of the data samples, and P(X=x₀|cⱼ) (where j=1, 2, . . . , N) represent conditional probabilities and corresponds to the proportion of the number of occurrences of value x₀ in data samples that have a value grade of

In embodiments where all possible P(X) and P(X|cⱼ) are precomputed and stored, the applicable values for this visitor are looked up based on the characteristics of the current visitor. In embodiments where the values are not precomputed, P(X) and P(X|cⱼ) are determined for X=x₀ and j=1, 2, . . . , N, using data samples in real time after visitor information for visitor X is obtained.

At 210, the conditional probabilities of value grades for the visitor given his/her visitor characteristic information is computed according to Bayes Rule as follows:

$$P ( {c}_{j} \vert X ) = \frac{P ( X \vert {c}_{j} )}{P ( X )} , wherein j = 1 , 2 , … N .$$

The conditional probabilities are equivalently to occurrence rate of cⱼ given the condition that a specific value of X is determined.

Where the values of P(X|cⱼ), P(cⱼ) and P(X) have been determined in the foregoing steps, and then the value of P(cⱼ|X) can be determined when j=1, 2, . . . N to represent the probabilities that the value grade of the visitor is c₁, c₂, or c_{N} given a specific value of X. This result can also be represented in the form of a table, e.g., Table 2:

TABLE 2

| Grade | Probability |
|---|---|
| c₁ | P(c₁\|X) |
| c₂ | P(c₂\|X) |
| . . . | . . . |
| c_{N} | P(c_{N}\|X) |

Since c₁, c₂, . . . c_{N} constitute a full set of all possible events,

P(c₁|X)+P(c₂|X)+ . . . +P(c_{N}|X)=1

The value of the visitor can be evaluated according to the result in Table 2. In some embodiments, for example, cⱼ yielding the maximum value of P(cⱼ|X) is deemed to be the likely grade value for the visitor. In some embodiments, the results of Table 2 are fed back to the website to be further processed instead of directly presenting the final evaluation result. For example, when there are multiple values of P(cⱼ|X) which are identical or slightly different, the relevant information on the visitor and the probability calculation result can be fed back to the website, which in turn can notify the administrator to evaluate the value of the visitor manually.

212 is an optional step implemented in some embodiments. Based on the evaluation result, it is determined whether further actions should be taken with respect to the visitor. In some embodiments, the value grade of the visitor is compared with a threshold, and if the threshold is exceeded, certain action is triggered. For example, the website/other processing components of the website/the website owner may be notified about the presence of a highly valued visitor so that personal attention (such as personalized messages) may be given to the visitor while he is on the website.

In response to an actual service demand, if the visitor information includes only relatively static visitor attribute information, then an evaluation result is considered to be invariant as long as the service demand remains the same. If the visitor information includes dynamically varying visitor behavior information, then the corresponding evaluation result should also vary dynamically. In this case, user information is updated either automatically or manually, and the value of the visitor is recomputed.

The following example illustrates the process described above. Assuming that a website sells products targeting users with different genders and in different age ranges. Factors considered for evaluating the value of a visitor include the gender of the visitor, the age of the visitor and the number of accesses to the website. A visitor can receive to two grades: “potential customer” and “general visitor”. It is assumed that c₁ represents “potential customer” and c₀ represents “general visitor”. First the probabilities that the “potential customer” and the “general visitor” occur in a set of data samples are determined respectively as P(c₁) and P(c₀). The determination can be made by tracking the number of all visitors to the website, and in particular the ones who eventually made purchases. In this example, the historical data shows that out of 1000 visitors, 50 made purchases. P(c₁) and P(c₀) are therefore 5% and 95%, respectively. Further:

X₁ represents the “visitor gender” and takes on the values of {Male, Female};

X₂ represents the “visitor age”, and its range of values is divided into three parts: {younger than 20 years, 20 to 40 years old, older than 40 years}; and

X₃ represents “the number of accesses to the website”, and its range of values is divided into two parts: {fewer than 5 times, 5 times and more}.

In this example, the statistical values of visitor information are determined in advance. According to the multiplication principle, there are 2×3×2=12 combinations of visitor conditions. Since X₁, X₂ and X₃ are mutually independent, two values of P(X₁), three values of P(X₂) and two values of P(X₃) can be determined by counting the rate of occurrence of each condition in the historical data, and then combined by multiplying the values according to twelve combinations of P(X₁ X₂ X₃). As an example, the following probabilities are determined based on historical data:

P {Male, younger than 20 years, fewer than 5 times}=10%

P {Male, younger than 20 years, 5 times and more}=5%

P {Male, 20 to 40 years old, fewer than 5 times}=3%

P {Male, 20 to 40 years old, 5 times and more}=15%

P {Male, older than 40 years, fewer than 5 times}=6%

P {Male, older than 40 years, 5 times and more}=35%

P {Female, younger than 20 years, fewer than 5 times}=2%

P {Female, younger than 20 years, 5 times and more}=1%

P {Female, 20 to 40 years old, fewer than 5 times}=4%

P {Female, 20 to 40 years old, 5 times and more}=8%

P {Female, older than 40 years, fewer than 5 times}=6%

P {Female, older than 40 years, 5 times and more}=5%

Twelve combinations of P(X₁ X₂ X₃|c₁) and twelve values of P(X₁ X₂ X₃|c₀) (i.e., probability of conditions X₁, X₂, and X₃ for general visitor) can be further determined by determining the occurrence rates of different combinations of conditions X₁, X₂, and X₃ for a potential customer, and the occurrence rates of combinations of conditions X₁, X₂, and X₃ for a general visitor, respectively.

Once the statistical values are determined, when a visitor arrives at the website, the gender, age and number of accesses to the website by the visitor are obtained. That is, a specific value of the visitor information of the visitor is determined as x₀, and then P(c₁|X=x₀) and P(c₀|X=x₀) are calculated from relevant statistical probability values of the specific value.

In this example, the gender and age information of the visitor is obtained from registration information of the visitor, and the number of accesses of the website by the visitor is obtained from a log of the website and is discretized. Thus, the visitor now maps to a specific one of the twelve combinations of visitor information.

After the visitor information is discretized, corresponding P(X₁ X₂ X₃) as well as corresponding P(X₁ X₂ X₃|c₁) and P(X₁ X₂ X₃|c₀) can be determined by computations based on previous statistical probability data. Assuming a new visitor accesses the website, the specific value x₀ of his visitor information is:

x₀={X₁=“Male”, X₂=“above 40 years old”, X₃=“below 5 times”}

P(c₁|X=x₀) and P(c₀|X=x₀) can be determined respectively applying the formula

$$P ( {c}_{j} \vert X ) = \frac{P ( X \vert {c}_{j} ) P ( {c}_{j} )}{P ( X )} .$$

If P(c₁|X=x₀) is greater than P(c₀|X=x₀), then the visitor is a “potential customer”; else, the visitor is a “general visitor”.

In the present embodiment, the gender of a visitor will not vary, and the age of the visitor can also be considered as a value that will not vary in a short term. However, “the number of accesses to the website” is a value that may vary dynamically over time. Therefore, this value may be updated regularly to enable dynamic evaluation of the value of the visitor.

In some embodiments, an alarm generator can further be arranged to monitor in real time an evaluation result of the value of a visitor. When an evaluation result of a “potential consumer” arises (or when P(c₁|X=x₀) is above a threshold), an output device of a computer at the website host is triggered, and the website owner is notified, for example, through voice, a visual screen change, etc. This way, the website owner only needs to pay special attention to a small number of visitors that “have value” and operating efficiency is improved.

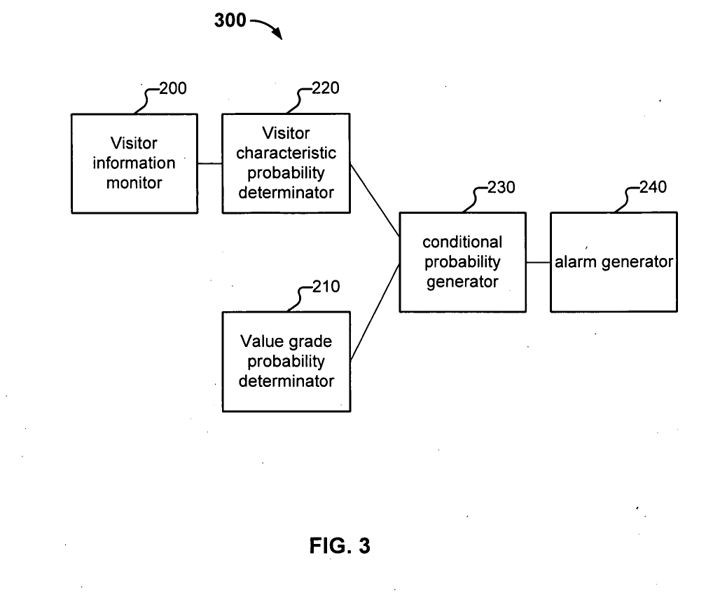

FIG. 3 is a block diagram illustrating an embodiment of a system for evaluating a value grade of a visitor. System 300 may be implemented using one or more computing devices such as a personal computer, a server computer, a handheld or portable device, a flat panel device, a multi-processor system, a microprocessor based system, a set-top box, a programmable consumer electronic device, a network PC, a minicomputer, a large-scale computer, a special purpose device, a distributed computing environment including any of the foregoing systems or devices, or other hardware/software/firmware combination that includes one or more processors, and memory coupled to the processors and configured to provide the processors with instructions.

The system includes a visitor information monitor 200, a value grade probability determination unit 210, a visitor characteristic probability determinator 220, a calculation unit 230, and an alarm generator 240.

The visitor information monitor is adapted to monitor characteristic information of visitors to the website, both for generating historical data and for facilitating the evaluation of a current visitor. In some embodiments, the visitor information monitor obtains at least a part of the visitor's characteristic information from registration information of the visitor, management logs, website cookies, customer relation management database, and/or any other appropriate visitor data storage or a combination thereof. The visitor information monitor is configurable to retrieve information in real time or periodically from visitor data storage locations.

The value grade probability determinator is adapted to determine the rate of occurrence of each of predetermined value grades cⱼ of website visitors in data samples as P(cⱼ), where j=1, 2, . . . , N, and N is the number of the predetermined value grades. The visitor probability determinator is adapted to determine the visitor characteristic probability P(X) and the value grades P(X|cⱼ) of a current visitor, based on the characteristic information determined by the visitor information monitor. The conditional probability generator is adapted to calculate the conditional value grade probabilities given the visitor characteristic of the current website visitor

$$P ( {c}_{j} \vert X ) = \frac{P ( X \vert {c}_{j} ) P ( {c}_{j} )}{P ( X )} ( j = 1 , 2 , … N ) .$$

Based on the calculated values, the conditional probability generator further selects a likely value grade for the current website visitor. In some embodiments, the value grade that results in the maximum conditional value grade probability is chosen as the likely value grade.

The alarm generator is adapted to monitor in real time the conditional probability result generated by the conditional probability generator, compare the result with predefined threshold, and generate an alarm (visual, audio, or the like) if the threshold is exceeded.

The visitor information probability determination unit 220 can calculate P(X) and P(X|cⱼ) in real time from the information on the website visitor X.

Those skilled in the art can appreciate that the visitor information monitor can provide a calculation model with information on multiple visitors at a time, and that the value grade probability determinator for probability calculation can evaluate the value grades of the visitors sequentially or in parallel in various embodiments. The alarm generator can also feed concurrently the identifiers as well as values and evaluation results of the visitors back to the website host.

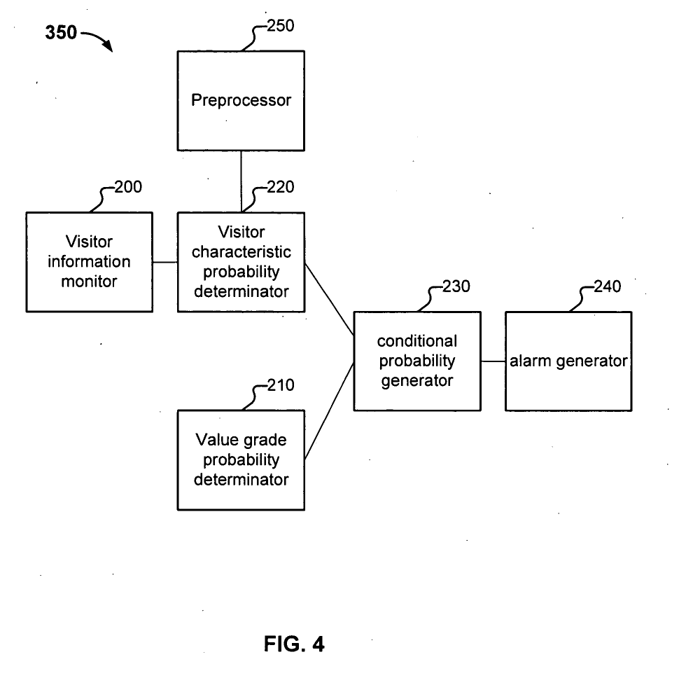

FIG. 4 is a block diagram illustrating another embodiment of a system for evaluating a value grade of a visitor. System 350 is similar to 300, with the addition of a visitor information probability preprocessor 250 that is adapted to pre-calculate the visitor characteristic probabilities P(X) and value grades P(X|cⱼ) for all of possible combinations of X, and to store the calculation results. Correspondingly, the visitor characteristic probability determinator 220 can obtain P(X) and P(X|cⱼ) based on characteristic information of a current website visitor, from stored calculation results by the preprocessor.

In some embodiments, even when characteristic information includes at least two characteristic components that are not mutually independent, the preprocessor still assumes that these components are mutually independent and calculate corresponding P(X) and P(X|cⱼ) based upon this assumption.

System 350 additionally includes a value grade determinator 260 adapted to determine cⱼ corresponding to the maximum value of P(cⱼ|X) as the evaluated value grade of the visitor, and the alarm unit 240 can also be adapted to monitor and output in real time an evaluation result of the visitor value of the evaluated grade determination unit 250.

The device as disclosed above evaluates the value of a new visitor based upon making statistics of historical data samples. Since the historical data samples can reflect effectively a manual evaluation criterion, the foregoing device can be used to evaluate the value of a visitor to determine an evaluation result tending to be consistent with manual evaluation.

The components described above can be implemented as software components executing on one or more general purpose processors, as hardware such as programmable logic devices and/or Application Specific Integrated Circuits designed to perform certain functions or a combination thereof. In some embodiments, the components can be embodied by a form of software products which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The components may be implemented on a single device or distributed across multiple devices. The functions of the components may be merged into one another or further split into multiple sub-components.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for evaluating website visitors, comprising:
obtaining historical sample information of a plurality of past website visitors;
based on the historical sample information, determining a plurality of value grades (cⱼ) of the past website visitors and a respective plurality of rates of occurrence (P(cⱼ)) for the plurality of value grades, wherein j=1, . . . , N, and N is an integer;
determining a visitor characteristic probability (P(X)) and a plurality of conditional visitor characteristic probabilities given the plurality of value grades (P(X|cⱼ)) associated with a current website visitor; and
determining a plurality of conditional value grade probabilities given a visitor characteristic of the current website visitor ((P(cⱼ|X)) and selecting among the plurality of conditional value grade probabilities a likely value grade associated with the current website visitor, wherein j=1, . . . , N.

2. The method of claim 1, further comprising, based on the likely value grade, determining whether any additional action is to be taken with respect to the current website visitor.

3. The method of claim 1, wherein determining the visitor characteristic probability (P(X)) and the plurality of conditional visitor characteristic probabilities given the plurality of value grades (P(X|cⱼ)) includes computing P(X) and P(X|cⱼ) in real-time.

4. The method of claim 1, wherein determining the visitor characteristic probability (P(X)) and the plurality of conditional visitor characteristic probabilities given the plurality of value grades (P(X|cⱼ)) includes:
precomputing possible values of P(X) and P(X|cⱼ) and storing precomputed results;
looking up applicable P(X) and P(X|cⱼ) for the current website visitor in the stored precomputed results.

5. The method of claim 4, wherein precomputing possible values of P(X) comprises assuming that X comprises characteristic components that are mutually independent.

6. The method of claim 1, wherein the likely value grade associated with the current website visitor corresponds to cⱼ that yields the maximum value of P(cⱼ|X).

7. The method of claim 1, wherein determining P(X) and P(X|cⱼ) includes obtaining characteristic information on the website visitor.

8. The method of claim 7, wherein obtaining characteristic information on the website visitor includes obtaining registration information of the website visitor.

9. The method of claim 7, wherein obtaining characteristic information on the website visitor includes obtaining information from a management system of the website.

10. The method of claim 2, wherein determining whether any additional action is to be taken with respect to the current website visitor includes comparing the likely value grade with a threshold.

11. A system for evaluating website visitors, comprising:
one or more processors configured to:
obtain historical sample information of a plurality of past website visitors;
based on the historical sample information, determine a plurality of value grades (cⱼ) of the past website visitors and a respective plurality of rates of occurrence (P(cⱼ)) for the plurality of value grades, wherein j=1, . . . , N, and N is an integer;
determine a visitor characteristic probability (P(X)) and a plurality of conditional visitor characteristic probabilities given the plurality of value grades (P(X|cⱼ)) associated with a current website visitor; and
determine a plurality of conditional value grade probabilities given a visitor characteristic of the current website visitor ((P(cⱼ|X)) and selecting among the plurality of conditional value grade probabilities a likely value grade associated with the current website visitor, wherein j=1, . . . , N; and
one or more memories coupled to the one or more processors, configured to provide the processors with instructions.

12. The system of claim 11, wherein the one or more processors are further configured determine whether any additional action is to be taken with respect to the current website visitor based on the likely value grade.

13. The system of claim 11, wherein determining the visitor characteristic probability (P(X)) and the plurality of conditional visitor characteristic probabilities given the plurality of value grades (P(X|cⱼ)) includes computing P(X) and P(X|cⱼ) in real-time.

14. The system of claim 11, wherein determining the visitor characteristic probability (P(X)) and the plurality of conditional visitor characteristic probabilities given the plurality of value grades (P(X|cⱼ)) includes:
precomputing possible values of P(X) and P(X|cⱼ) and storing precomputed results;
looking up applicable P(X) and P(X|cⱼ) for the current website visitor in the stored precomputed results.

15. The system of claim 14, wherein precomputing possible values of P(X) comprises assuming that X comprises characteristic components that are mutually independent.

16. The system of claim 11, wherein the likely value grade associated with the current website visitor corresponds to cⱼ that yields the maximum value of P(cⱼ|X).

17. The system of claim 11, wherein determining P(X) and P(X|cⱼ) includes obtaining characteristic information on the website visitor.

18. The system of claim 17, wherein obtaining characteristic information on the website visitor includes obtaining registration information of the website visitor.

19. The system of claim 17, wherein obtaining characteristic information on the website visitor includes obtaining information from a management system of the website.

20. The system of claim 12, wherein determining whether any additional action is to be taken with respect to the current website visitor includes comparing the likely value grade with a threshold.

21. A computer program product for monitoring performance of insurance transactions, the computer program product being embodied in a computer readable storage medium and comprising computer instructions for:
obtaining historical sample information of a plurality of past website visitors;
based on the historical sample information, determining a plurality of value grades (cⱼ) of the past website visitors and a respective plurality of rates of occurrence (P(cⱼ)) for the plurality of value grades, wherein j=1, . . . , N, and N is an integer;
determining a visitor characteristic probability (P(X)) and a plurality of conditional visitor characteristic probabilities given the plurality of value grades (P(X|cⱼ)) associated with a current website visitor; and
determining a plurality of conditional value grade probabilities given a visitor characteristic of the current website visitor ((P(cⱼ|X)) and selecting among the plurality of conditional value grade probabilities a likely value grade associated with the current website visitor, wherein j=1, . . . , N.
